(19) United States
(12) Patent Application Publication
(10) Pub. No.: US 2009/0009789 A1
(43) Pub. Date: Jan. 8, 2009

(54) IMAGE FORMING APPARATUS, DOCUMENT MANAGEMENT METHOD, AND COMPUTER PROGRAM PRODUCT

(76) Inventor: Fumiyuki Yoshida, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/166,475

(22) Filed: Jul. 2, 2008

(30) Foreign Application Priority Data
Jul. 5, 2007 (JP) 2007-177127
Jun. 18, 2008 (JP) 2008-159624

(51) Int. Cl. G06F 3/12

(52) U.S. Cl. 358/1.14

(57) ABSTRACT

With widely-used standard techniques (RSS, HTTP, and Basic authentication), there is realized a function of storing electronic document data via a network, a function of notifying a user of an update status of the electronic document data through the RSS, and a function of printing the electronic document data through a Web browser.

### CROSS-REFERENCE TO RELATED APPLICATIONS

The present application claims priority to and incorporates by reference the entire contents of Japanese priority document 2007-177127 filed in Japan on Jul. 5, 2007 and 2008-159624 filed in Japan on Jun. 18, 2008.

### BACKGROUND OF THE INVENTION

1. Field of the Invention

The present invention relates to an image forming apparatus, a document management method, and a computer program product.

2. Description of the Related Art

As a technology related to an image forming apparatus, there has been disclosed such a technology that, for example, in a case where a user needs to register himself to use a service by transmitting predetermined information to a service providing apparatus, if the user registration is cancelled, the user can re-register himself again without any trouble (for example, see Japanese Patent Application Laid-open No. 2006-134110 and Japanese Patent Application Laid-open No. 2006-134109). Furthermore, there has been disclosed, for example, see Japanese Patent Application Laid-open No. 2006-54732, such a technology that a user can quickly retrieve information about statuses of a plurality of multifunction products, such as a communication history of each of the multifunction products, via a computer.

Japanese Patent Application Laid-open No. 2006-134110 and Japanese Patent Application Laid-open No. 2006-134109 disclose an image forming apparatus (a multifunction product) including a function of notifying a user of an update status of an electronic document with an RSS feeder by the application of RSS (Rich Site Summary, RDF Site Summary, Really Simple Syndication), HTTP (Hypertext Transfer Protocol), Basic authentication, and the like that are standard techniques widely-used now. With these techniques and a technique enabling a user to print out a document through a Web browser, more various types of clients (external terminals used by users) can cause the image forming apparatus to manage a document and a printing job of the document. Furthermore, Japanese Patent Application Laid-open No. 2006-54732 discloses an image forming apparatus including an RSS function.

In the technologies disclosed in Japanese Patent Application Laid-open No. 2006-134110 and Japanese Patent Application Laid-open No. 2006-134109, to cope with traffic caused by the application of the RSS, a specific protocol has been created. Therefore, a widely-distributed RSS reader cannot be used, so that a client supporting the specific protocol needs to be developed separately.

Consequently, the number of man-hour in a manufacturer's development section increases, and thus a cost also increases. In addition, it is only a user of the client supporting the specific protocol that can know a status of a service. Therefore, a type of the client applicable to the image forming apparatus is limited.

Furthermore, in the technology disclosed in Japanese Patent Application Laid-open No. 2006-54732, the image forming apparatus can manage its own operations, such as a notification of a remaining amount of toner, with the RSS function. However, the image forming apparatus does not support functions for general users. For example, the image forming apparatus does not have a function of enabling a user to save image data in the image forming apparatus through a network or a function of updating a status of the image data.

### SUMMARY OF THE INVENTION

It is an object of the present invention to at least partially solve the problems in the conventional technology.

According to an aspect of the present invention, there is provided an image forming apparatus including a communicating unit that can perform data communication with an external terminal via a network; a storage unit in which data can be stored; a data-storage control unit that stores electronic document data transmitted from the external terminal and received by the communicating unit in the storage unit; and a printing unit that prints out the electronic document data stored in the storage unit upon receiving a printing instruction for printing the electronic document data from the external terminal, wherein upon storing the electronic document data in the storage unit for a first time, the data-storage control unit creates a management document for managing an update status of the electronic document data, and stores the management document in the storage unit together with the electronic document data.

According to another aspect of the present invention, there is provided a document management method that is implemented in an image forming apparatus including a storage unit in which data can be stored. The document management method includes communicating with an external terminal via a network to establish data communication with the external terminal; storing electronic document data transmitted from the external terminal in the storage unit; printing out the electronic document data stored in the storage unit upon receipt of a printing instruction for printing the electronic document data from the external terminal; and creating a management document for managing an update status of the electronic document data upon storing the electronic document data in the storage unit for a first time and storing the management document in the storage unit together with the electronic document data.

According to still another aspect of the present invention, there is provided a computer program product including computer program codes stored on a computer-readable recording medium which when executed on a computer causes the computer to realize the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of functions of an image forming apparatus according to a first embodiment of the present invention;

FIG. 2 is a schematic diagram of an example of an additional-user registration screen;

FIG. 3 is a flowchart of an additional-user registering process;

FIG. 4 is a schematic diagram for explaining a usage state of each of areas of a secondary storage device after the additional-user registering process is performed;

FIG. 5 is a sequence diagram of an electronic-document uploading process;

FIG. 6 is a schematic diagram of an example of a document upload screen;

FIG. 7 is a schematic diagram of an example of a screen for registering an electronic document that an update status of which is to be notified;

FIG. 8 is a sequence diagram of a process of registering an electronic document that an update status of which is to be notified;

FIG. 9 is a sequence diagram of a process of notifying a user of an update status of the registered electronic document;

FIG. 10 is a schematic diagram for explaining a relation between a user-specific RSS document and a document-specific RSS document;

FIG. 11 is a schematic diagram of an example of a document-printing selection screen for registering an electronic document to be printed out;

FIG. 12 is a schematic diagram of an example of a screen for notifying a user of completion of a printing process;

FIG. 13 is a sequence diagram of a printing process of an electronic document instructed to be performed by a client;

FIG. 14 is a block diagram of functions of an image forming apparatus according to a second embodiment of the present invention;

FIG. 15 is a schematic diagram of an example of an update-status notification screen displayed on an RSS reader on a client; and

FIG. 16 is a sequence diagram of a process of notifying a user of an update status of an electronic document and a process of printing the electronic document those performed by the image forming apparatus shown in FIG. 14.

### DETAILED DESCRIPTION OF THE PREFERRED EMBODIMENTS

Exemplary embodiments of the present invention are explained in detail below with reference to the accompanying drawings.

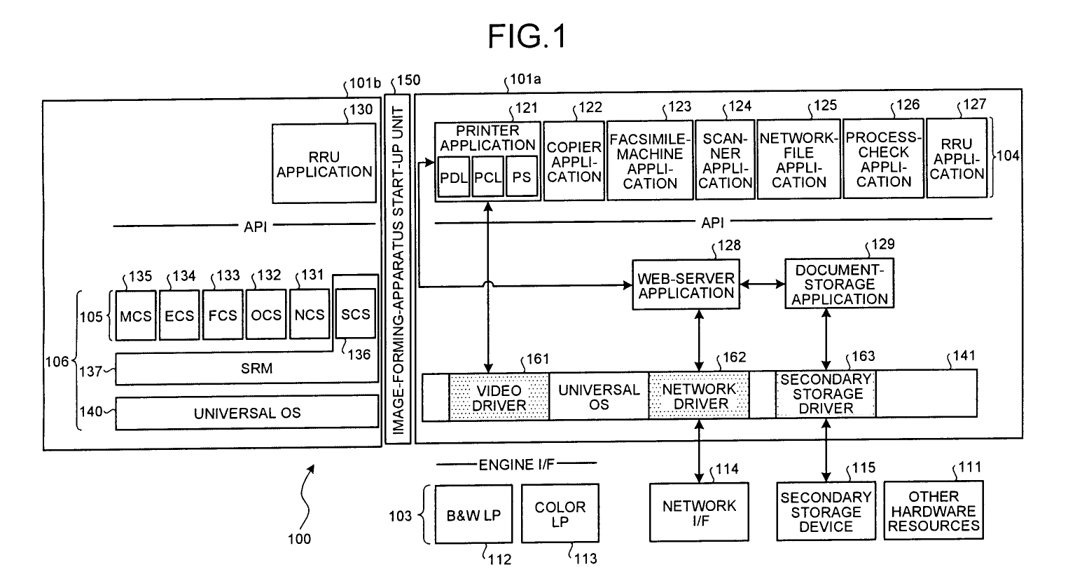

FIG. 1 is a block diagram of functions of an image forming apparatus (a multifunction product) 100 according to a first embodiment of the present invention. The image forming apparatus 100 incorporates functions (applications) of a printer, a copier, a facsimile machine, a scanner, and the like in all-in-one package. The image forming apparatus 100 includes software groups 101a and 101b as control units, an image-forming-apparatus start-up unit 150, and hardware resources 103.

When the image forming apparatus 100 is powered on, the image-forming-apparatus start-up unit 150 first activates an application layer 104 and a platform 106.

The hardware resources 103 include a black-and-white laser printer (B&W LP) 112, a color laser printer (color LP) 113, a network interface (I/F) 114, a secondary storage device 115, and other hardware resources 111 such as a scanner and a facsimile machine.

In the secondary storage device 115, user information including an identification (ID) and a password of a user who is permitted to access to the image forming apparatus 100 is stored in advance. Furthermore, electronic document data (hereinafter, “an electronic document”) can be stored in the secondary storage device 115.

The software group 101a includes the application layer 104 including applications to be run on a universal operating system (OS) 141 such as UNIX (registered trademark). The application layer 104 is a computer program(s) for causing a function related to an image formation, such as the printer, the copier, the facsimile machine, and the scanner, to perform a specific process. The application layer 104 includes a printer application 121 as an application for the printer, a copier application 122 as an application for the copier, a facsimile-machine application 123 as an application for the facsimile machine, a scanner application 124 as an application for the scanner, a network-file application 125 as an application for a network file, a process-check application 126 as an application for checking a process, an RRU application 127 as an application for remote ROM update (RRU), a Web-server application 128 as an application for a Web server, and a document-storage application 129 as an application for a document storage. The universal OS 141 includes various types of drivers, such as a video driver 161, a network driver 162, and a secondary storage driver 163.

The document-storage application 129 is an application for storing an electronic document received from a client connected to a network in the secondary storage device 115. When an electronic document is stored in the secondary storage device 115 for the first time, the document-storage application 129 creates an RSS document by each user (a user-specific RSS document) and an RSS document by each electronic document (a document-specific RSS document), which are management documents for managing an update status of the electronic document, and stores the electronic document together with the user-specific RSS document and the document-specific RSS document in the secondary storage device 115.

When the electronic document stored in the secondary storage device 115 is updated, the Web-server application 128 notifies a Web browser running on the client of an update status of the electronic document with reference to the user-specific RSS document and the document-specific RSS document with the use of an RSS feeder function.

Furthermore, when receiving an input of a printing instruction for printing the electronic document stored in the secondary storage device 115 through the Web browser on the client, the Web-server application 128 requests the printer application 121 to print out the electronic document indicated in the printing instruction.

Moreover, when the user accesses to the image forming apparatus 100 through the Web browser on the client, the Web-server application 128 authenticates the user based on the user information by the application of Basic authentication.

The software group 101b includes the platform 106 and an RRU application 130 to be run on a universal OS 140 such as UNIX (registered trademark). The RRU application 130 is an application for RRU like the RRU application 127. The platform 106 includes a control service layer 105, a system resource manager (SRM) 137, and the universal OS 140. The control service layer 105 interprets a request for a process from the application layer 104, and issues an acquisition request for acquiring a corresponding resource from the hardware resources 103. The SRM 137 manages the hardware resources 103, and mediates acquisition requests if there is a plurality of acquisition requests from the control service layer 105. The universal OS 140 supports any of the hardware resources 103 corresponding to the acquisition request received from the SRM 137.

The control service layer 105 includes one or more service modules. Specifically, the control service layer 105 includes a network control service (NCS) 131, an operation-panel control service (OCS) 132, a facsimile control service (FCS) 133, an engine control service (ECS) 134, a memory control service (MCS) 135, and a system control service (SCS) 136.

The platform 106 is configured to receive a request for a process from the application layer 104 via an application program interface (API) by a predefined function. The universal OSs 140 and 141 respectively execute any of the softwares included in the application layer 104 and the platform 106 as the requested process in parallel with each other.

The NCS 131 is used to provide a service that can be used among applications requiring a network input/output (I/O). Specifically, the NCS 131 realizes to distribute data received from the network side to any of the applications in accordance with a protocol and to mediate sets of data from the applications to be transmitted to the network side.

For example, the NCS 131 controls a data communication between the image forming apparatus 100 and a network device, which are connected to each other via the network, via the HTTP with a hypertext transfer protocol daemon (httpd). The OCS 132 is used to control an operation panel as an information transmitting unit for exchanging information between the user and the image forming apparatus 100.

The FCS 133 is used to provide an API for facsimile transmission/reception from the application layer 104 via an Integrated Services Digital Network (ISDN) or the like, a registration, a citation, and a reading of facsimile data, a printing of a received facsimile, and the like. The ECS 134 is used to control each of engines, such as the B&W LP 112, the color LP 113, and the other hardware resources 111. The MCS 135 is used to control an acquisition or release of an area of a system memory (not shown), utilization of a storage device (not shown), and the like. The SCS 136 is used to manage each of the applications, control an interruption of the application, and the like.

The SRM 137 is used to control the system and manage the hardware resources 103 together with the SCS 136. For example, the SRM 137 mediates acquisition requests for using any of the hardware resources 103, such as the B&W LP 112 or the color LP 113, from an upper layer, and controls which one of the acquisition requests to be executed. Specifically, the SRM 137 determines whether the one of the hardware resources 103 indicated in the acquisition request is available (whether the resource indicated in the acquisition request is not in use in response to the other acquisition request). If the resource is available, the SRM 137 notifies the upper layer that the one of the hardware resources 103 indicated in the acquisition request is available. Furthermore, the SRM 137 performs scheduling for using any of the hardware resources 103 indicated in an acquisition request from the upper layer, and directly executes a content of the request (for example, a sheet conveyance and an image formation by the printer engine, a reserve of an area in the system memory, a creation of a file, or the like).

The universal OS 141 includes device drivers (such as the video driver 161, the network driver 162, and the secondary storage driver 163) capable of providing information required for an operation of each of the hardware resources 103. The universal OS 141 is configured to be capable of controlling a communication I/F, such as a network I/F or a USB I/F. The image forming apparatus 100 is connected to an external device via the communication I/F so as to input/output image data to the external device.

Subsequently, an additional-user registering process for authentication performed by the image forming apparatus 100 is explained below. The image forming apparatus 100 has a function of registering (adding) “a user capable of uploading an electronic document to the secondary storage device 115 in the image forming apparatus 100”.

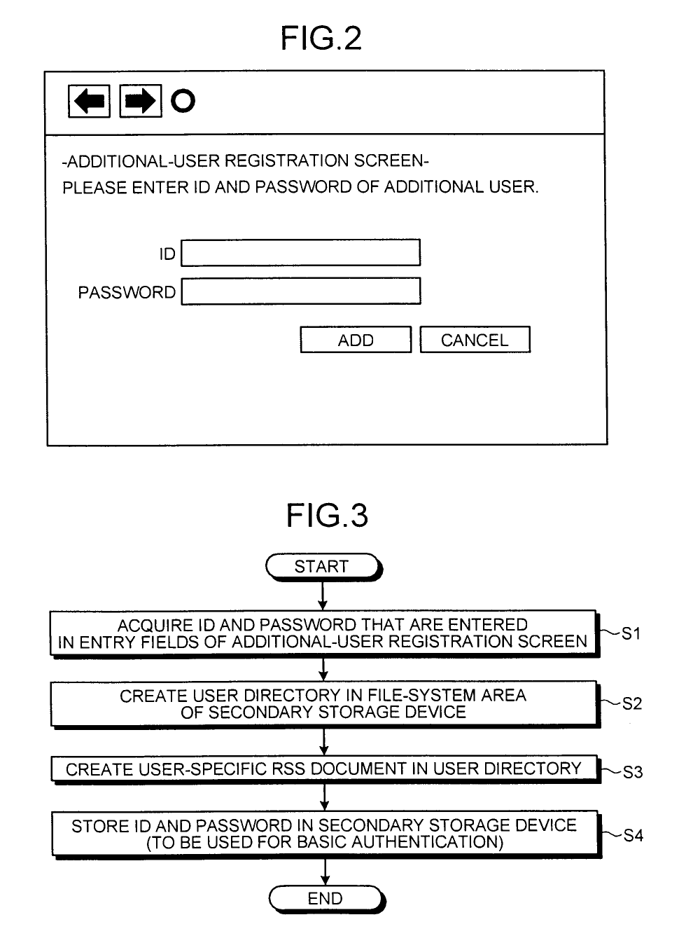

A person who manages users of the image forming apparatus 100 (an administrator) registers a unique character string for identifying a user (an ID) and a password required for user authentication as user information through a screen (an additional-user registration screen) shown in FIG. 2.

After the registration of the ID and the password, the administrator presses an “ADD” button on the screen shown in FIG. 2. By this operation, the ID and the password are stored in the secondary storage device 115. The ID and the password (the user information) are used for Basic authentication (RFC2617).

In addition, a directory having an ID identical to a user ID as a directory name and a user-specific RSS document to be created in the directory are also created in the secondary storage device 115. The user-specific RSS document is used when the user checks a registration status of the document.

FIG. 3 is a flowchart of the additional-user registering process. The ID and the password that are entered in entry fields of the additional-user registration screen shown in FIG. 2 are acquired (Step S1). A user directory is created in a file-system area of the secondary storage device 115 (Step S2). A user-specific RSS document is created in the created user directory (Step S3). The ID and the password those acquired at Step S1 are stored in the secondary storage device 115 (Step S4).

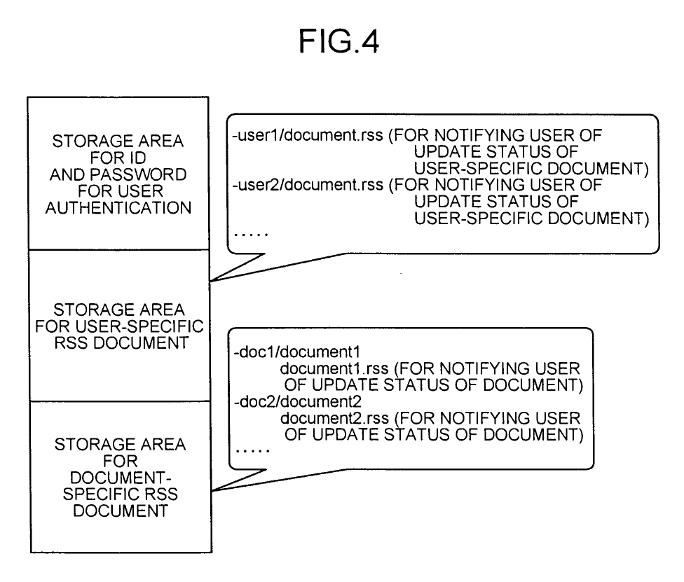

After the above process, a usage status of the area of the secondary storage device 115 is as shown in FIG. 4.

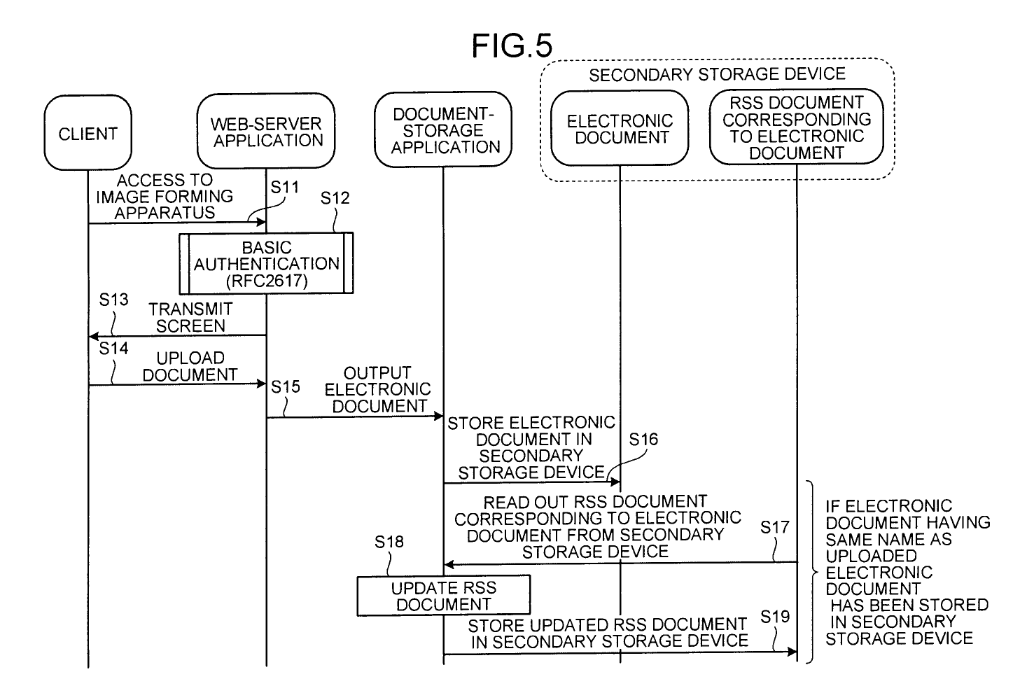

Furthermore, the image forming apparatus 100 also has a function of enabling the user registered in the additional-user registering process to upload an electronic document to the secondary storage device 115. FIG. 5 is a sequence diagram of an electronic-document uploading process.

A user accesses to the image forming apparatus 100 through a Web browser on a client (a terminal device connected to the image forming apparatus 100 via the network) (Step S11). In the image forming apparatus 100, this access is passed to the Web-server application 128 via the network I/F 114 and the network driver 162.

With user information (an ID and a password), user authentication is conducted (Step S12). As a method of the user authentication, the Basic authentication (RFC2617) is employed in the present embodiment. The Basic authentication is supported in almost all Web browsers, so that users of any types of clients can access to the image forming apparatus 100.

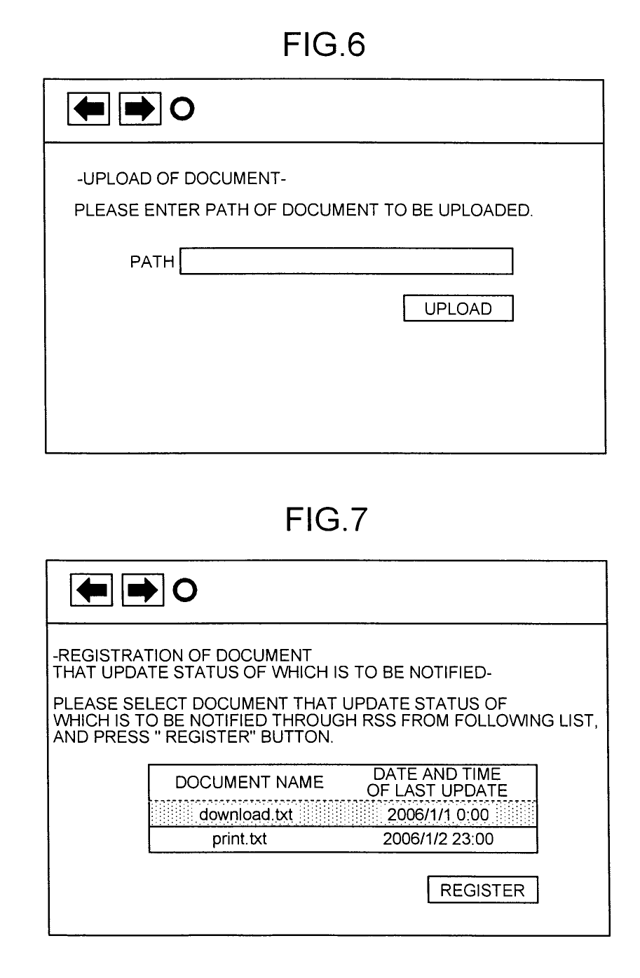

In the Basic authentication at Step S12, when the user accessing to the image forming apparatus 100 is determined as an authenticated user, the Web-server application 128 transmits a document upload screen shown in FIG. 6 to the client (Step S13).

The user enters a path of an electronic document to be uploaded through the screen shown in FIG. 6, which is displayed on the Web browser on the client, and then presses an “UPLOAD” button (Step S14). By this operation, the electronic document is uploaded to the secondary storage device 115 in the image forming apparatus 100.

When the electronic document has been uploaded at Step S14, the Web-server application 128 receives the electronic document via the HTTP. Upon completion of the reception of the electronic document, the Web-server application 128 outputs the electronic document to the document-storage application 129 (Step S15). Such an output is performed by an interprocess communication through a shared memory or a socket.

Upon completion of the reception of the electronic document from the Web-server application 128, the document-storage application 129 stores the received electronic document in the secondary storage device 115 via the secondary storage driver 163 (Step S16).

If an electronic document having the same document name as the uploaded electronic document has already existed (has been stored) in the secondary storage device 115, the document-storage application 129 reads out an RSS document one-to-one corresponding to the electronic document (hereinafter, “a document-specific RSS document”) from the secondary storage device 115 (Step S17), and updates the document-specific RSS document (Step S18), and then stores the updated document-specific RSS document in the secondary storage device 115 (Step S19).

If there is no electronic document having the same document name as the uploaded electronic document in the secondary storage device 115, i.e., the uploaded electronic document is a newly-created electronic document, the uploaded electronic document is stored in the secondary storage device 115, and “a document-specific RSS document” for the uploaded electronic document is newly created in the secondary storage device 115. Procedures in this case are not described in the flowchart shown in FIG. 5.

The document-specific RSS document is created to notify a user who wants to know an update status of the electronic document of the update status.

The document-specific RSS document is used to notify the user of an update status of the electronic document, so that data managed in the document-specific RSS document is only a date when the electronic document is changed and a file name.

In this manner, minimum information is managed in the document-specific RSS document, so that it is possible to reduce network traffic occurring during access through an RSS reader (a software for obtaining/purchasing an RSS or an Atom distributed through a weblog, a podcasting service, an online news site, and the like, and is also called “an aggregator” or “a feed reader”).

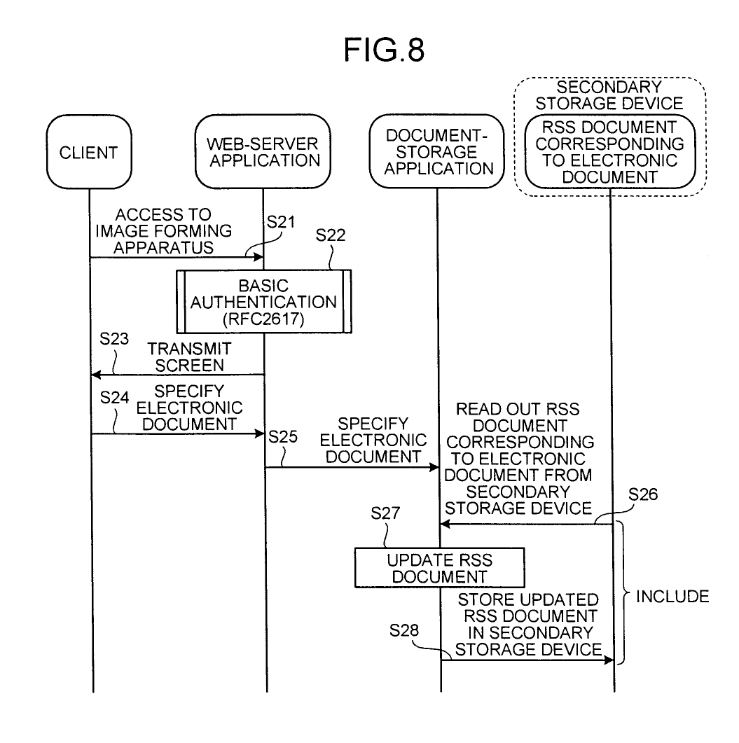

Subsequently, a process of registering an electronic document that a user wants to know an update status thereof is explained below. A user can select (specify) an electronic document that the user wants to know an update status thereof so as to register the electronic document in advance. The electronic document is registered through a screen shown in FIG. 7, which is displayed on the Web browser on the client. FIG. 8 is a sequence diagram of the process of registering an electronic document that an update status of which is to be notified.

The user accesses to the image forming apparatus 100 from the client (Step S21). When the user is successfully authenticated by the Basic authentication (Step S22), the Web-server application 128 transmits the screen shown in FIG. 7 (a document registration screen) to the client (Step S23). As a result, the screen shown in FIG. 7 is displayed on the Web browser on the client.

The user selects an electronic document that the user wants to know an update status thereof through the screen shown in FIG. 7 displayed on the client, and presses a “REGISTER” button. By this operation, a document name of the selected electronic document is transmitted from the client to the Web-server application 128 (Step S24).

Upon receiving the document name of the electronic document, the Web-server application 128 outputs the document name of the electronic document to the document-storage application 129 (Step S25). Upon receiving the document name of the electronic document, the document-storage application 129 causes a document-specific RSS document for the specified electronic document to be included in a user-specific RSS document for the user (Steps S26 to S28). Incidentally, a method of including one RSS document in the other RSS document is standardized, so that the description of the method is omitted.

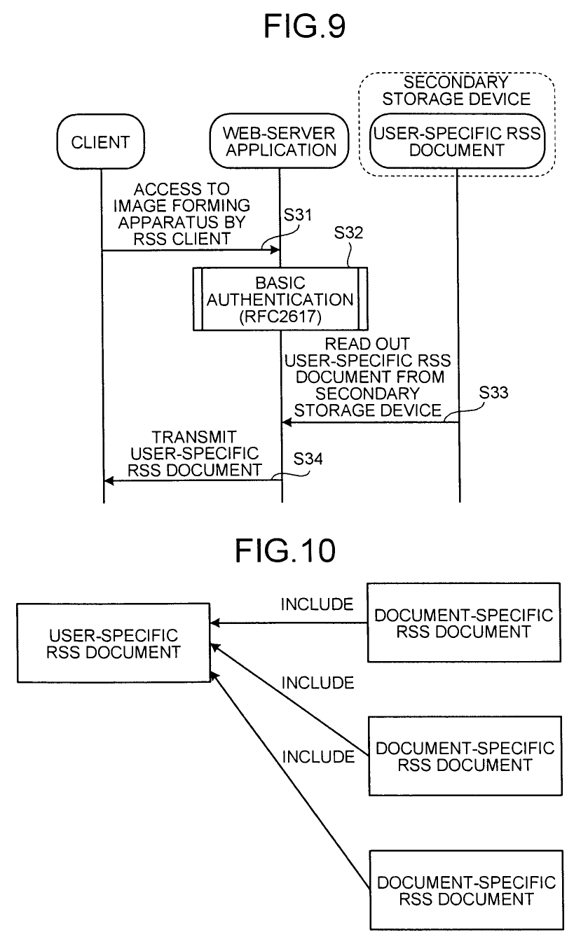

Subsequently, a process of notifying a user of an update status of a registered electronic document is explained below. The user can know an update status of an electronic document that is registered in advance as the one that the user wants to know an update status thereof. FIG. 9 is a sequence diagram of the process of notifying the user of an update status of the registered electronic document.

When the user wants to know an update status of the electronic document stored in the image forming apparatus 100 (the secondary storage device 115), the user accesses to a user-specific RSS document stored in the secondary storage device 115 via the Web-server application 128 at predetermined intervals through the RSS reader on the client (Step S31).

The Web-server application 128 conducts the Basic authentication of the user (Step S32). When the user accessing to the user-specific RSS document is matched with a holder of the user-specific RSS document, the Web-server application 128 accesses to the user-specific RSS document stored in the secondary storage device 115, and reads out the user-specific RSS document (Step S33), and then transmits the user-specific RSS document to the client (Step S34).

Incidentally, a relation between a user-specific RSS document and a document-specific RSS document can be illustrated as shown in FIG. 10. Namely, a plurality of document-specific RSS documents is included in one user-specific RSS document.

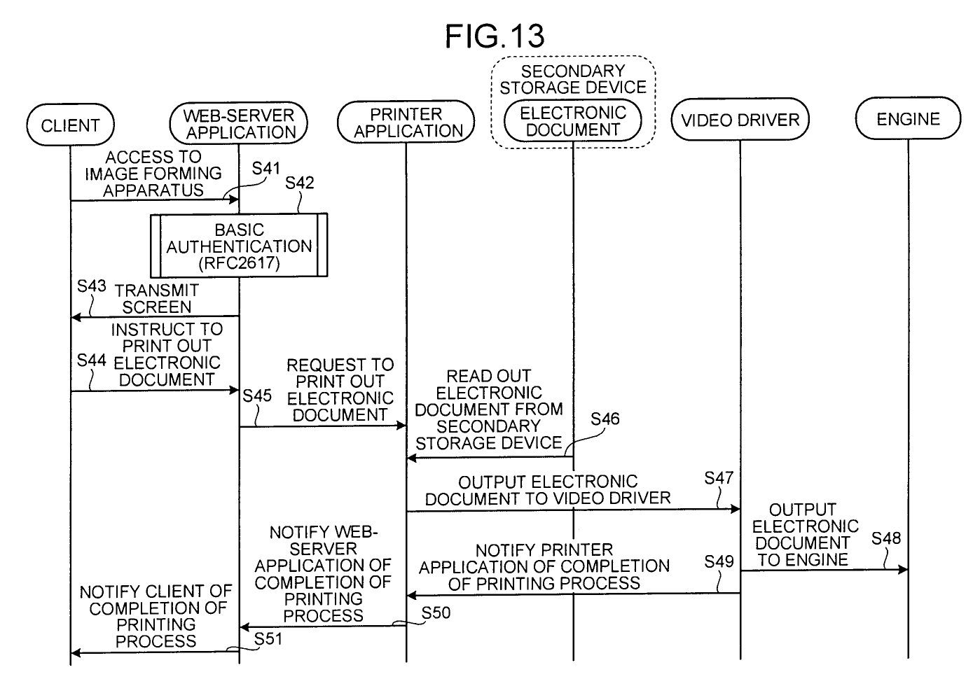

Subsequently, a printing process instructed to be performed through the Web browser is explained below. Through the Web browser of the client, a user can instruct the image forming apparatus 100 to print out an electronic document stored in the secondary storage device 115. FIG. 13 is a sequence diagram of the printing process instructed to be performed through the Web browser.

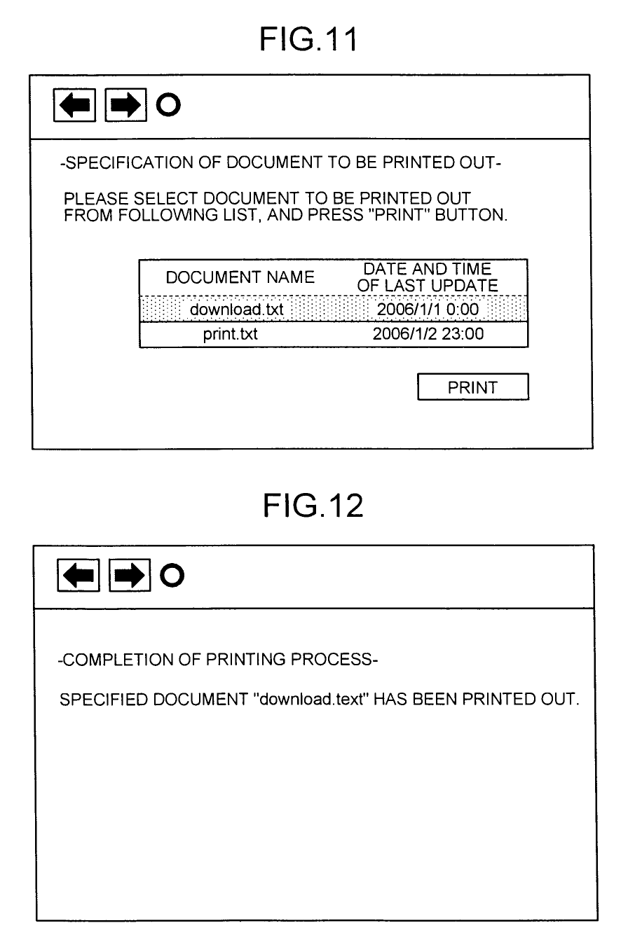

The user tries to access to a document-printing selection screen shown in FIG. 11 through the Web browser of the client (Step S41).

The Web-server application 128 conducts the Basic authentication of the user (Step S42). When the user is determined as an authenticated user, the Web-server application 128 transmits the document-printing selection screen shown in FIG. 11 to the client (Step S43). As a result, the screen shown in FIG. 11 is displayed on the client.

The user selects (specifies) an electronic document to be printed out through the screen shown in FIG. 11, and presses a “PRINT” button. By this operation, a printing instruction including a document name of the electronic document to be printed out is notified to the image forming apparatus 100 (the Web-server application 128) (Step S44).

Upon receiving the printing instruction, the Web-server application 128 acquires the document name of the electronic document to be printed out from the printing instruction, and notifies the printer application 121 of a printing request including the acquired document name (Step S45). Upon receiving the printing request, the printer application 121 extracts the document name of the electronic document to be printed out from the printing request, and acquires the electronic document having the extracted document name (i.e., the electronic document to be printed out) from the secondary storage device 115 (Step S46). After that, the printer application 121 outputs the acquired electronic document to the video driver 161 so as to print out the electronic document (Step S47).

The video driver 161 outputs the electronic document to the engine (the B&W LP 112 or the color LP 113) via the engine I/F (Step S48).

After the engine has printed out the electronic document, the video driver 161 notifies the printer application 121 of completion of the printing process (Step S49).

Similarly, the printer application 121 notifies the Web-server application 128 of the completion of the printing process (Step S50). The Web-server application 128 transmits a screen for notifying the completion of the printing process to the client (Step S51). As a result, for example, a screen shown in FIG. 12 is displayed on the client.

As explained above, the image forming apparatus 100 includes the secondary storage device 115, and can receive data from other terminals (clients). Therefore, the image forming apparatus 100 can store an electronic document (electronic document data) received from other terminals in the secondary storage device 115.

Furthermore, the image forming apparatus 100 has the function of registering user information (an ID and a password). Therefore, only a registered user can use the image forming apparatus 100.

Moreover, the image forming apparatus 100 conducts user authentication of a user who accesses to the image forming apparatus 100. Therefore, only an authenticated user can use the image forming apparatus 100.

Furthermore, in the image forming apparatus 100, when an electronic document is stored in the secondary storage device 115, a document-specific RSS document is created. Therefore, a user can know an update status of the electronic document.

Moreover, in the image forming apparatus 100, when an electronic document stored in the secondary storage device 115 is updated, a document-specific RSS document of the electronic document is also updated. Therefore, when a user accesses to the document-specific RSS document, the user can correctly know an update status of the electronic document.

Furthermore, in the image forming apparatus 100, a user can instruct the image forming apparatus 100 to execute a printing job through a Web browser of a user's client. Therefore, it is not necessary to provide a device driver for printing. In addition, the image forming apparatus 100 can execute a printing job upon receiving instructions from many clients.

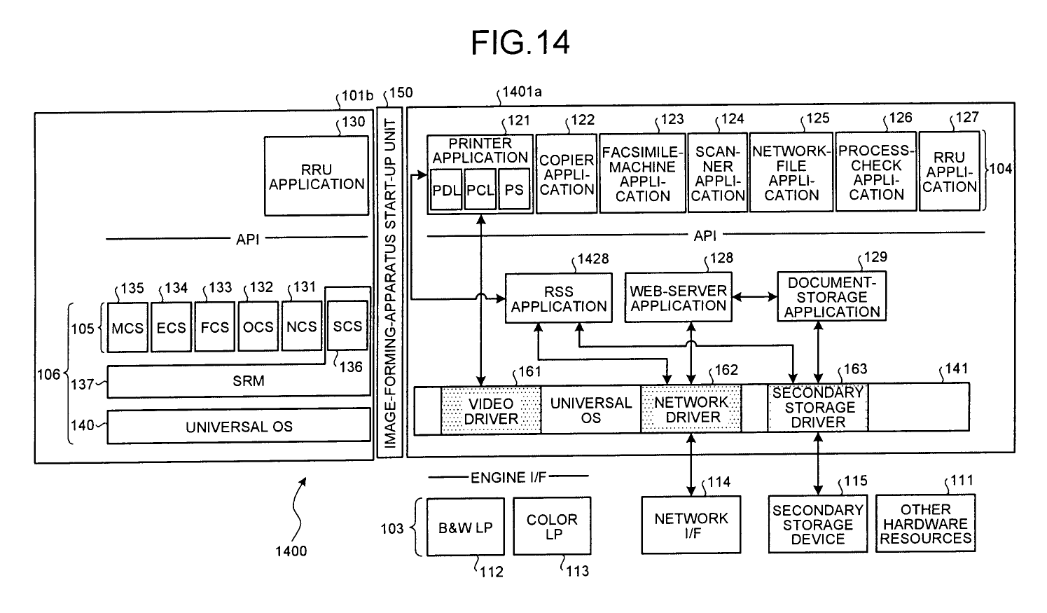

FIG. 14 is a block diagram of functions of an image forming apparatus (a multifunction product) 1400 according to a second embodiment of the present invention. In the same manner as the image forming apparatus 100, the image forming apparatus 1400 incorporates applications of a printer, a copier, a facsimile machine, a scanner, and the like in all-in-one package. A basic configuration of the image forming apparatus 1400 is almost identical to that of the image forming apparatus 100. The portions identical to those in FIG. 1 are denoted with the same reference numerals, and the description of those portions is omitted. A difference between the image forming apparatus 100 and the image forming apparatus 1400 is that the image forming apparatus 1400 includes a software group 1401a instead of the software group 101a. The software group 1401a further includes an RSS application 1428 in addition to those included in the software group 101a.

The RSS application 1428 is an application for notifying an RSS reader running on a client of an update status of an electronic document by the use of an RSS feeder function as a standard function. Incidentally, the RSS reader running on the client can be a dedicated application of the client, or can operate through a Web browser of the client in the same manner as that is in the first embodiment. In the second embodiment, it is assumed that the RSS reader running on the client is a dedicated application of the client.

Specifically, the RSS application 1428 includes a function of displaying an updated content of electronic document data as an update status of the electronic document on the RSS reader on the client. Upon receiving a user's instruction for printing an electronic document that an update status of which is notified from the client, the RSS application 1428 outputs a printing request for printing the electronic document indicated in the printing instruction to the printer application 121.

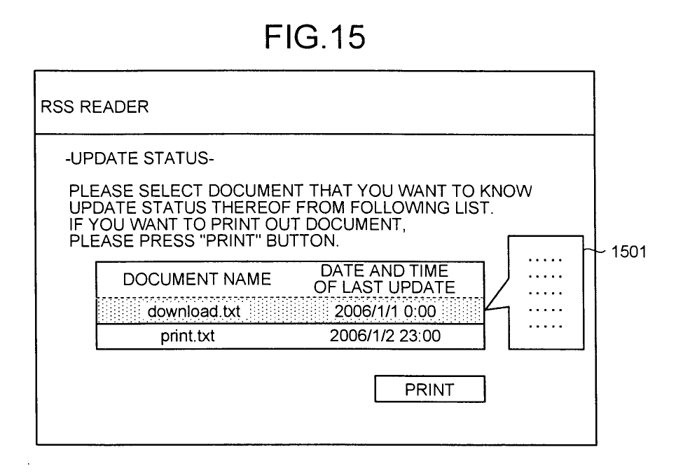

FIG. 15 is a schematic diagram of an example of an update-status notification screen displayed on the RSS reader on the client. As shown in FIG. 15, a list window on which a document name and date and time of last update of each of updated electronic documents are displayed is displayed on a screen of the RSS reader. When a user selects an electronic document that the user wants to know an update status thereof from the list window by clicking on it with a mouse, a window 1501 on which an updated content of the electronic document is displayed is displayed on the screen of the RSS reader. Furthermore, after the user selects the electronic document from the list window, if the user wants to print out the selected electronic document, the user clicks on a “PRINT” button, whereby the selected electronic document is printed out.

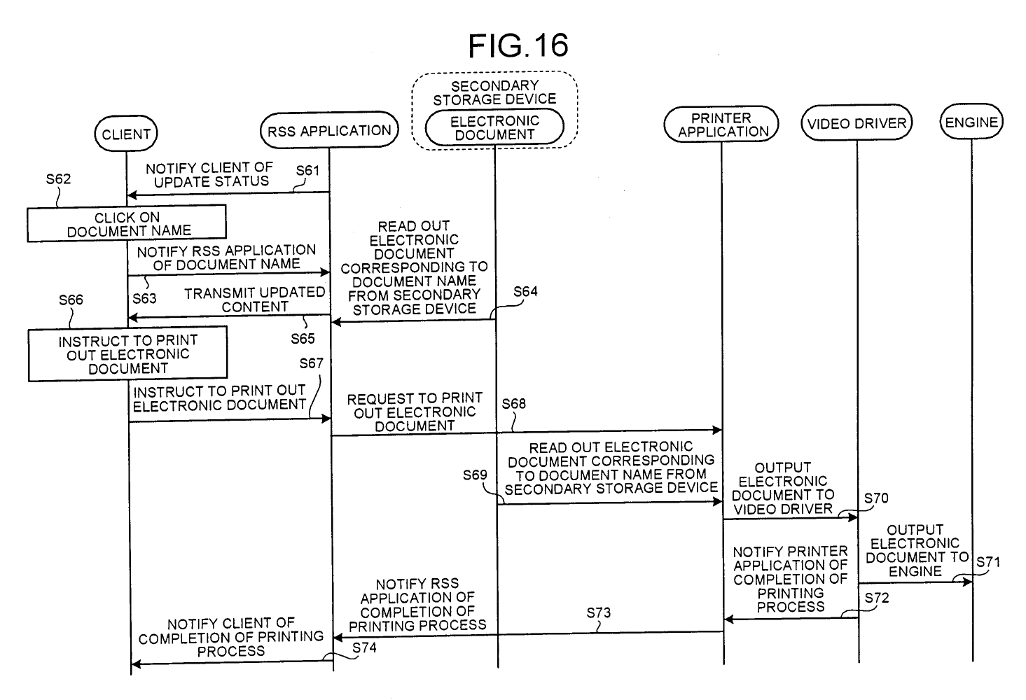

Subsequently, a process of notifying a user of an update status of an electronic document and a process of printing the electronic document those performed by the image forming apparatus 1400 are explained below. FIG. 16 is a sequence diagram of these processes performed by the image forming apparatus 1400.

When an electronic document stored in the secondary storage device 115 is updated, the RSS application 1428 transmits an update notification including a document name and date and time of last update of the updated electronic document, as an update status, to a client (Step S61). Upon receiving the update notification, the client displays the update-status notification screen shown in FIG. 15 on the RSS reader.

When a user clicks on a document name of a desired electronic document displayed on the update-status notification screen with a mouse (Step S62), the client accepts the selection of the electronic document, and transmits the document name of the electronic document to the image forming apparatus 1400 (Step S63).

In the image forming apparatus 1400, the RSS application 1428 receives the document name via the network I/F 114 and the network driver 162, and reads out the electronic document corresponding to the received document name from the secondary storage device 115 via the secondary storage driver 163 (Step S64). Then, the RSS application 1428 extracts an updated content of the electronic document, and transmits the updated content to the client via the network driver 162 and the network I/F 114 (Step S65).

In the client, the updated content is displayed on the update-status notification screen of the RSS reader in the form of the window 1501 shown in FIG. 15. When the user clicks on the “PRINT” button after the user selects any of document names listed on the list window, the client accepts the selection of the document name as a printing instruction for printing an electronic document corresponding to the selected document name (Step S66), and transmits the printing instruction including the selected document name of the electronic document to be printed out to the image forming apparatus 1400 (Step S67).

In the image forming apparatus 1400, the RSS application 1428 receives the printing instruction via the network I/F 114 and the network driver 162, and outputs a printing request including the document name indicated in the printing instruction to the printer application 121 (Step S68). Upon receiving the printing request, the printer application 121 extracts the document name from the printing request, and acquires an electronic document corresponding to the extracted document name (i.e., an electronic document to be printed out) from the secondary storage device 115 (Step S69). After that, the printer application 121 outputs the acquired electronic document to the video driver 161 to print out the electronic document (Step S70).

Upon receiving the electronic document, the video driver 161 outputs the electronic document to the engine (the B&W LP 112 or the color LP 113) via the engine I/F (Step S71).

After the electronic document has been printed out by the engine, the video driver 161 notifies the printer application 121 of completion of the printing process (Step S72).

Similarly, the printer application 121 notifies the RSS application 1428 of the completion of the printing process (Step S73). The RSS application 1428 transmits the same screen as shown in FIG. 12 to the client to notify the client of the completion of the printing process (Step S74). As a result, for example, the screen shown in FIG. 12 is displayed on the client.

Incidentally, the image forming apparatus 1400 performs user authentication and a registration of an electronic document that an update status of which is to be notified to the user in the same manner as the image forming apparatus 100, so that the description of those processes is omitted.

In this manner, the image forming apparatus 1400 further includes the RSS-specific RSS application 1428 so that the RSS application 1428 performs a notification of an update status of an electronic document. Therefore, a functional division of the applications can be performed more efficiently as compared with the image forming apparatus 100 in which the Web-server application 128 performs a notification of an update status of an electronic document. Thus, the number of man-hour in a manufacturer's development section can be reduced.

Furthermore, in addition to the notification of an update status of an electronic document, the RSS application 1428 displays an updated content of the electronic document on the client so that the user can recognize the updated content first, and then print out the electronic document. Therefore, the image forming apparatus 1400 is so user-friendly that the user can print out the desired electronic document.

Although the exemplary embodiments of the present invention are explained above, the present invention is not limited to the embodiments. A variety of modifications and variations can be made without departing from the scope of the invention.

The present invention can be applied to an apparatus, a device, and a system those capable of storing therein data received from other terminals and updating the stored data and also to a method and a computer program for storing data received from other terminals and updating the stored data.

According to the present invention, with widely-used standard techniques, an electronic document can be stored in an image forming apparatus via a network, whereby it is possible to unify the management of documents in an office. Furthermore, there is realized a function of notifying a user of an update status of an electronic document so that the updated electronic document can be printed out if the user wants. Therefore, the user can recognize the update of the electronic document, and print out the updated electronic document through an external terminal, such as a mobile phone or a thin client. Consequently, electronic documents can be easily managed in an office or the like. In addition, more various types of clients can use the image forming apparatus, and thus it can be expected that the image forming apparatus is utilized in a broad range of applications. Moreover, it is possible to reduce the number of man-hour in a manufacturer's development section.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a communicating unit that can perform data communication with an external terminal via a network;
a storage unit in which data can be stored;
a data-storage control unit that stores electronic document data transmitted from the external terminal and received by the communicating unit in the storage unit; and
a printing unit that prints out the electronic document data stored in the storage unit upon receiving a printing instruction for printing the electronic document data from the external terminal, wherein upon storing the electronic document data in the storage unit for a first time, the data-storage control unit creates a management document for managing an update status of the electronic document data, and stores the management document in the storage unit together with the electronic document data.

2. The image forming apparatus according to claim 1, further comprising a notifying unit that notifies the external terminal of an update status of the electronic document data based on the management document when the electronic document data stored in the storage unit is updated.

3. The image forming apparatus according to claim 2, wherein the notifying unit notifies the external terminal of the update status of the electronic document data with an RSS (Rich Site Summary, RDF Site Summary, Really Simple Syndication) feeder function.

4. The image forming apparatus according to claim 3, wherein the notifying unit notifies a WEB browser displayed on the external terminal of the update status.

5. The image forming apparatus according to claim 3, wherein the notifying unit displays an updated content of the electronic document data on the external terminal.

6. The image forming apparatus according to claim 5, wherein the notifying unit includes an application for displaying the updated content of the electronic document data as the update status on the external terminal.

7. The image forming apparatus according to claim 2, wherein upon receiving a user's printing instruction for printing the electronic document data that the update status of which is notified from the external terminal, the notifying unit outputs a printing request for printing the electronic document data indicated in the printing instruction to the printing unit.

8. The image forming apparatus according to claim 1, further comprising:
a user-information storage unit in which user information used for authentication of a user accessing to the image forming apparatus through the external terminal is registered in advance; and
an authenticating unit that authenticates the user of the external terminal based on the user information when the image forming apparatus is accessed through the external terminal.

9. A document management method that is implemented in an image forming apparatus including a storage unit in which data can be stored, the document management method comprising:
communicating with an external terminal via a network to establish data communication with the external terminal;
storing electronic document data transmitted from the external terminal in the storage unit;
printing out the electronic document data stored in the storage unit upon receipt of a printing instruction for printing the electronic document data from the external terminal; and
creating a management document for managing an update status of the electronic document data upon storing the electronic document data in the storage unit for a first time and storing the management document in the storage unit together with the electronic document data.

10. The document management method according to claim 9, further comprising notifying the external terminal of an update status of the electronic document data based on the management document when the electronic document data stored in the storage unit is updated.

11. The document management method according to claim 10, wherein the notifying includes notifying the external terminal of the update status of the electronic document data with an RSS (Rich Site Summary, RDF Site Summary, Really Simple Syndication) feeder function.

12. The document management method according to claim 11, wherein the notifying includes notifying a WEB browser displayed on the external terminal of the update status.

13. The document management method according to claim 11, wherein the notifying includes displaying an updated content of the electronic document data on the external terminal.

14. The document management method according to claim 13, wherein the notifying includes displaying the updated content of the electronic document data as the update status on the external terminal.

15. The document management method according to claim 10, wherein the printing includes, upon receiving a user's printing instruction for printing the electronic document data that the update status of which is notified from the external terminal, printing the electronic document data indicated in the printing instruction.

16. The document management method according to claim 9, further comprising:
storing user information used for authentication of a user accessing to the image forming apparatus through the external terminal in a user-information storage unit in advance; and
authenticating the user of the external terminal based on the user information when the image forming apparatus is accessed through the external terminal.

17. A computer program product including computer program codes stored on a computer-readable recording medium which when executed on a computer causes the computer to execute:
communicating with an external terminal via a network to establish data communication with the external terminal;
storing electronic document data transmitted from the external terminal in a storage unit;
printing out the electronic document data stored in the storage unit upon receipt of a printing instruction for printing the electronic document data from the external terminal; and
creating a management document for managing an update status of the electronic document data upon storing the electronic document data in the storage unit for a first time and storing the management document in the storage unit together with the electronic document data.
